(19) United States
(12) Patent Application Publication
(10) Pub. No.: US 2010/0162768 A1
(43) Pub. Date: Jul. 1, 2010

(54) METHOD AND APPARATUS FOR MANUFACTURING OPTICAL FIBER PREFORM USING HIGH FREQUENCY INDUCTION THERMAL PLASMA TORCH

(75) Inventor: Tetsuya OTOSAKA, Gunma (JP)

Correspondence Address: Masao Yoshimura, 333 W. El Camino Real, Suite 380, Sunnyvale, CA, 94087, US

(73) Assignee: SHIN-ETSU CHEMICAL CO., LTD., Tokyo (JP)

(21) Appl. No.: 12/647,289

(22) Filed: Dec. 24, 2009

(30) Foreign Application Priority Data
Dec. 26, 2008 (JP) 2008-333748

(51) Int. Cl. C03B 37/018

(52) U.S. Cl. 65/391; 65/152

(57) ABSTRACT

Provided is an optical fiber preform manufacturing method comprising supplying a high-frequency induction thermal plasma torch with at least glass raw material, dopant raw material, and oxygen, and depositing the glass particles synthesized in the plasma flame onto a surface of a glass rod that moves backward and forward relative to the plasma torch while rotating, wherein the plasma flame is narrowed such that at least a portion of the glass particles continuously formed by the plasma flame are not deposited on the glass rod. As a result, the fluorine concentration in the cladding is increased to improve the relative refractive index difference of the preform.

### BACKGROUND

1. Technical Field

The present invention relates to a method and an apparatus for manufacturing an optical fiber preform using a high frequency induction thermal plasma torch. The present application claims priority from a Japanese Patent Application No. 2008-333748 filed on Dec. 26, 2008, the contents of which are incorporated herein by reference.

2. Related Art

A high frequency induction thermal plasma torch is an apparatus provided with a high frequency coil on a periphery of a gas flow tube, and a high frequency current is applied to ionize the gas therein and emit the resulting plasma from a nozzle. Such a high frequency induction thermal plasma torch can achieve extremely high temperatures around 10,000 degrees, has relatively low plasma velocity, and enables free selection of oxidation and reduction atmosphere, and is therefore used as an ultra-high temperature reaction field.

An optical fiber formed by covering a pure silica glass core with a fluorine-doped silica glass cladding is more durable with regard to UV rays and radiation than a commonly used optical fiber that is formed by covering a germanium-doped silica glass core with a pure silica glass cladding. This greater durability is due to the absence of Ge—O bonding, which has low bonding energy.

Two methods that are known for providing the fluorine-doped silica glass cladding on the pure silica glass core include (1) forming a porous glass layer by depositing pure silica glass particles on the periphery of a pure silica glass rod and converting the glass particles into transparent glass in a fluorine atmosphere, as disclosed in Japanese Examined Patent Application Publication No. 4-79981, and (2) using a plasma flame on a periphery of a pure silica glass rod to directly deposit fluorine-doped silica glass, as disclosed in Japanese Examined Patent Application Publication No. 2-47414.

In method (1), the relative refractive index difference Δ is limited to less than approximately 0.7%, and so method (1) is suitable for achieving favorable throughput and providing a thick cladding layer. Method (2) has inferior throughput compared to method (1), but can acheive a relative refractive index difference Δ greater than 0.7%. The relative refractive index difference Δ is defined below in Expression 1.

Δ=(n_{core}−n_{clad})/n_{core} Expression 1

Here, n_{core} and n_{clad} represent the refractive indices of the core and the cladding.

Method (2) is described using FIG. 1. A coil 2 is provided to a plasma torch 1, and when high-frequency power is applied to the coil 2, gas supplied from a gas supply apparatus 3 is ionized in the plasma torch 1 and emitted as a plasma flame 4. The supplied gas may include argon, oxygen, silicon tetrachloride, a glass including fluorine such as silicon tetrafluoride, ethane hexafluoride, and sulfur hexafluoride, and the like.

Fluorine-doped glass particles are generated in the plasma flame 4, and these fluorine-doped glass particles are deposited on a surface of a glass rod 6, i.e. a target, that moves up and down while rotating in a reaction chamber 5. Exhaust gas and glass particles that are not affixed to the glass rod 6 are expelled from the system via an exhaust outlet 7. By repeatedly depositing a thin film of the fluorine-doped glass particles in this way, an optical fiber preform is manufactured having a cladding layer with a desired thickness. In FIG. 1, reference numeral 8 indicates forced cooling nozzles and reference numeral 9 indicates cool air induction apertures.

Japanese Patent Application No. 2007-142423 discloses a technique that involves supplying glass particles to a glass rod 6 moving symmetrically forward and backward over a plasma torch 1, only when the glass rod 6 moves forward. The supply of glass raw material is stopped while the glass rod 6 moves backward, and the plasma temperature is lowered and then quickly returned to the original temperature. As a result, the refractive index of the cladding can be stabilized in a longitudinal direction.

The numerical aperture NA of an optical fiber obtained by heating, melting, and drawing a preform is shown below in Expression 2.

NA=(n_{core}²−n_{clad}²)^{1/2} Expression 2

Here, NA is a parameter representing a spread angle of light that can be received by the optical fiber, and so a higher value for NA means that the optical fiber can transmit light received from a larger range of directions.

In the optical fiber formed from a pure silica core and fluorine-doped cladding dealt with here, n_{core} is approximately 1.457 and n_{clad} changes according to the fluorine concentration. NA and relative refractive index difference Δ are correlated with each other, such that NA increases when the relative refractive index difference is greater.

### SUMMARY

Therefore, it is an object of an aspect of the innovations herein to provide a method and an apparatus for manufacturing an optical fiber preform using a high frequency induction thermal plasma torch, which are capable of improving the relative refractive index difference of a preform by increasing the fluorine concentration doped in the cladding. The above and other objects can be achieved by combinations described in the independent claims. The dependent claims define further advantageous and exemplary combinations of the innovations herein.

The optical fiber preform manufacturing method according to the present invention involves supplying a high-frequency induction thermal plasma torch with at least glass raw material, dopant raw material, and oxygen, and depositing the glass particles synthesized in the plasma flame onto a surface of a glass rod that moves backward and forward relative to the plasma torch while rotating, wherein the plasma flame is narrowed such that at least a portion of the glass particles continuously formed by the plasma flame are not deposited on the glass rod.

A gas blown toward the glass particle flow may be blown toward the glass particle flow causing the hottest region in the peripheral temperature distribution of the glass rod. In order to prevent deposition of a portion of the glass particle flow, the gas may be blown toward a portion of the glass particle stream that is forward with respect to the movement or rotation of the glass rod. As another example, the gas may be blown at the glass particle stream along the glass rod from a forward region thereof.

The optical fiber preform manufacturing apparatus according to the present invention supplies a high-frequency induction thermal plasma torch with at least glass raw material, dopant raw material, and oxygen, and deposits the glass particles synthesized in the plasma flame onto a surface of a glass rod that moves backward and forward relative to the plasma torch while rotating, and is provided with a deposition obstructing component that narrows the plasma flame such that at least a portion of the glass particles continuously formed by the plasma flame are not deposited on the glass rod.

The deposition obstructing component is provided is a deposition obstruction nozzle provided on the apparatus on a forward side relative to the movement of the glass rod, and blows gas toward the glass particle flow in a forward region of the glass rod. As another example, the deposition obstructing section may be a gas guide tube through which the glass rod is passed, and at least a portion of the deposition of the glass particle flow may be obstructed by blowing a gas along the glass rod to the glass particle flow from a gap between the gas guide tube and the glass rod.

By preventing deposition of at least a portion of the glass particle flow formed in the plasma flame onto the glass rod, the present invention can increase the fluorine concentration in the cladding to improve the relative refractive index difference of the preform.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a schematic cross-sectional view of an optical fiber preform manufacturing apparatus provided with a conventional high-frequency induction thermal plasma torch.

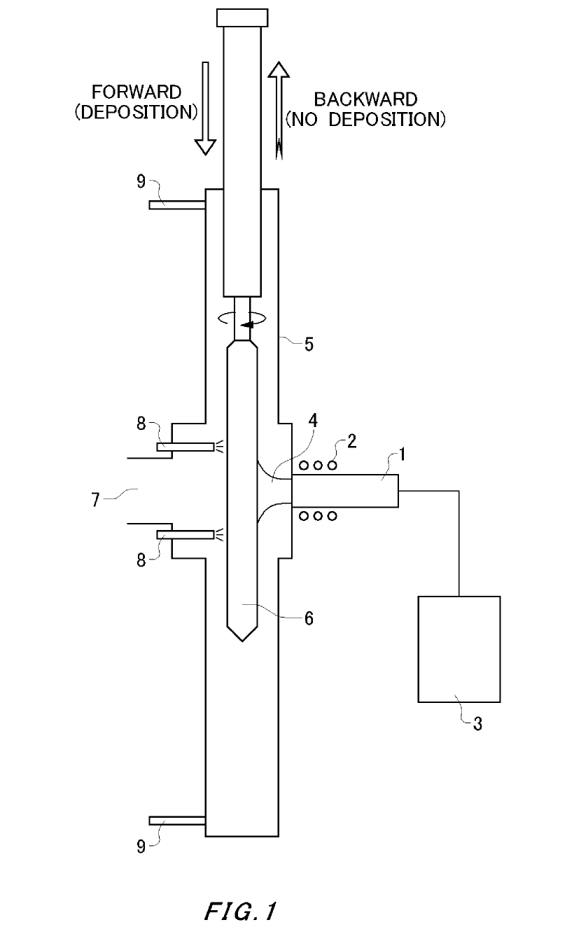

FIG. 2 shows the plasma torch along with a relationship between temperature, deposition amount, and relative refractive index difference Δ measured along the movement direction of the glass rod.

FIG. 3 is a schematic cross-sectional view of the manufacturing apparatus according to the present invention.

FIG. 4 is a schematic cross-sectional view of the manufacturing apparatus according to the present invention in a different state than shown in FIG. 3.

FIG. 5 is a schematic view of an exemplary positioning of the deposition obstructing gas nozzle according to the present invention.

FIG. 6 is a schematic view of an exemplary positioning of the deposition obstructing gas nozzle according to the present invention.

FIG. 7 shows a temperature distribution over the surface of the glass rod relative to the rotation and movement of the glass rod.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

The flow of glass particles in a plasma flame is divided upon contact with a glass rod to flow forward and backward along the direction in which the glass rod moves. At this time, the refractive index of a glass film instantaneously deposited by the flow of glass particles differs in a portion in front of the contact point and a portion behind the contact point, i.e. the flow differs in the direction of movement of the glass rod. The present invention is based on this difference.

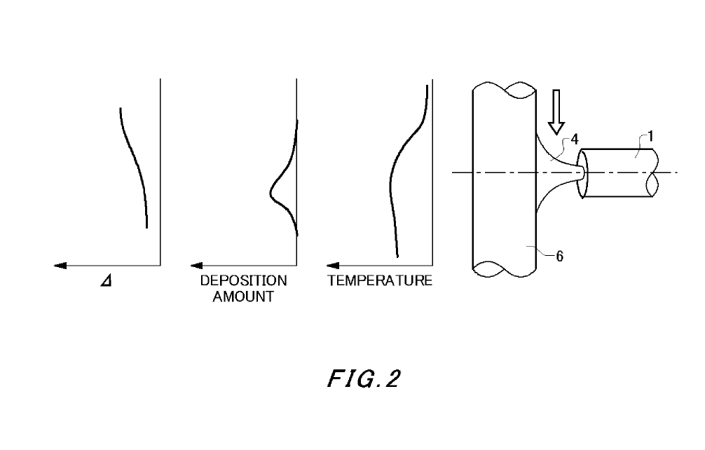

FIG. 2 shows the plasma torch 1 along with temperature, deposition amount, and the relative refractive index difference Δ measured along the direction of movement of the glass rod 6. The portion of the glass rod 6 on the forward side, which is downward in FIG. 2, results in higher temperatures since this portion has already been heated by the plasma flame 4. Furthermore, in this forward portion, the amount of affixed glass particles is greater and the fluorine doping amount is lower, which results in a lower relative refractive index difference Δ.

Based on the observations of FIG. 2, it was determined that since the region having a relatively high temperature has a large amount of deposition but a small amount of fluorine doping, which results in a low relative refractive index difference, the relative refractive index difference Δ of the deposition layer can be improved by decreasing the temperature in the hottest region by moving this region from the center of the flame to a position slightly farther away in the direction of motion of the glass rod 6 or in a direction of rotation of the glass rod 6. Therefore, the present invention achieves a higher relative refractive index difference Δ by lowering the temperature of the hottest region to increase the fluorine doping amount and by obstructing the deposition of at least a portion of the glass particles. The present invention achieves this effect by narrowing the flame flow to retract an edge of the flame in the forward direction of the glass rod 6 or in the downward rotational direction of the glass rod 6. More specifically, the present invention uses a deposition obstructing gas nozzle to blow gas toward the glass particle flow that is directed at the hottest region on the surface of the glass rod 6.

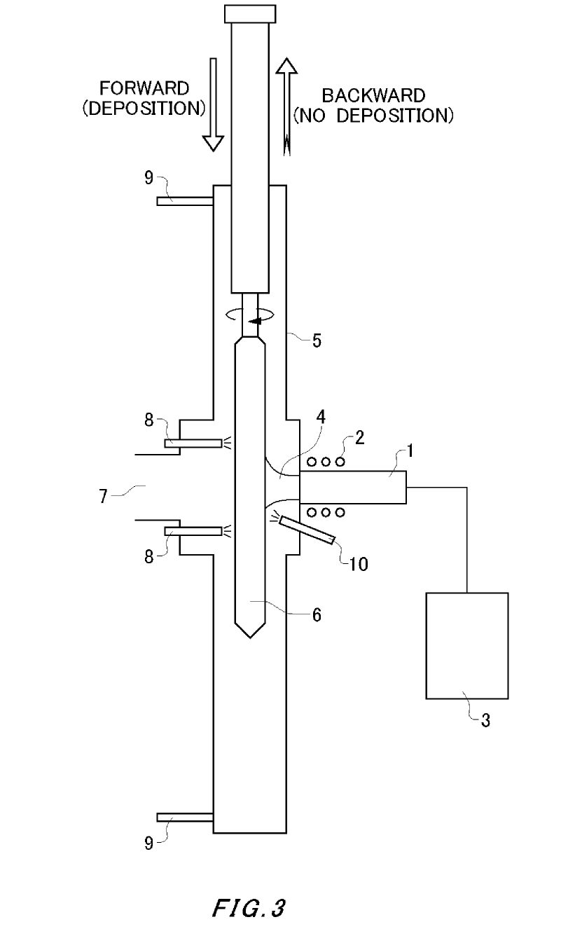

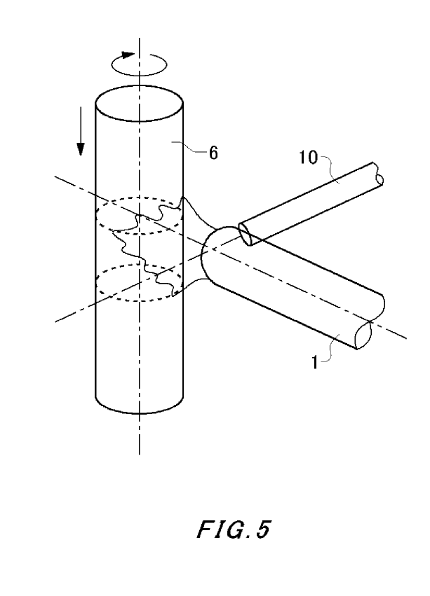

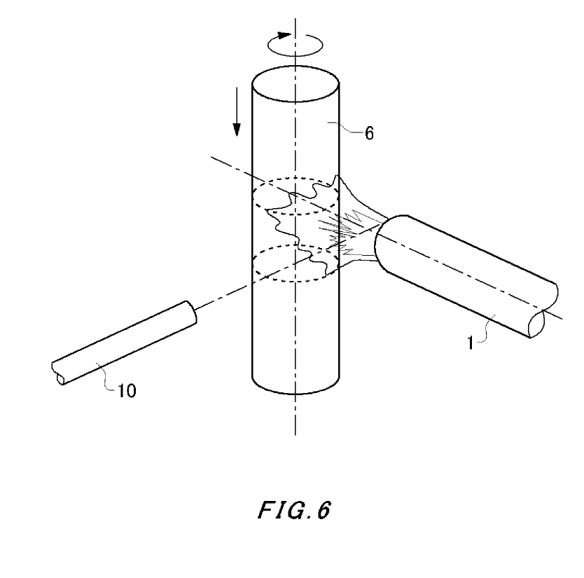

One exemplary technique for preventing deposition of at least a portion of the glass particle flow on the forward side of the glass rod 6 involves using the deposition obstructing gas nozzle 10 shown in FIG. 3 to obstruct the glass particle deposition. This deposition obstructing gas nozzle 10 is provided on the same side as the plasma torch 1, but if the structure of the apparatus makes this position of the gas nozzle 10 difficult or if a malfunction occurs due to unaffixed glass particles being deposited on the tip of the deposition obstructing gas nozzle 10, the deposition obstructing gas nozzle 10 may instead be positioned at a 90-degree angle, for example, as shown in FIGS. 5 and 6.

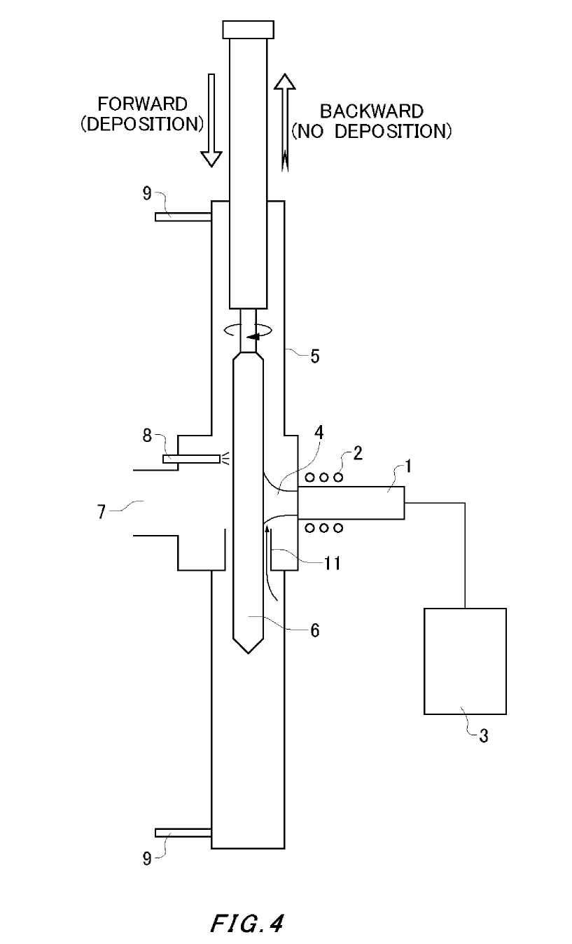

Another exemplary technique for preventing deposition of at least a portion of the glass particle flow on the forward side of the glass rod 6 involves using the gas guide tube 11 shown in FIG. 4. With this technique, the gas is blown on the glass particle flow from the forward side of the glass rod 6, which is downward in FIG. 4, along the length of the glass rod 6.

The gas guide tube 11 is provided immediately below the plasma flame 4. The gas guide tube 11 directs the air entering from a cool air induction aperture 9 provided at the bottom reaction chamber through the space between the glass rod 6 and the gas guide tube 11 into the plasma flame 4 along the glass rod 6. As a result, deposition of a portion of the glass particles below the plasma flame 4, i.e. on the forward side of the glass rod 6, is obstructed. Since it is easy for the deposition of unaffixed glass particles to occur on the plasma torch side of the gas guide tube 11, it is desirable to carve away a portion of the gas guide tube 11 on the plasma torch side.

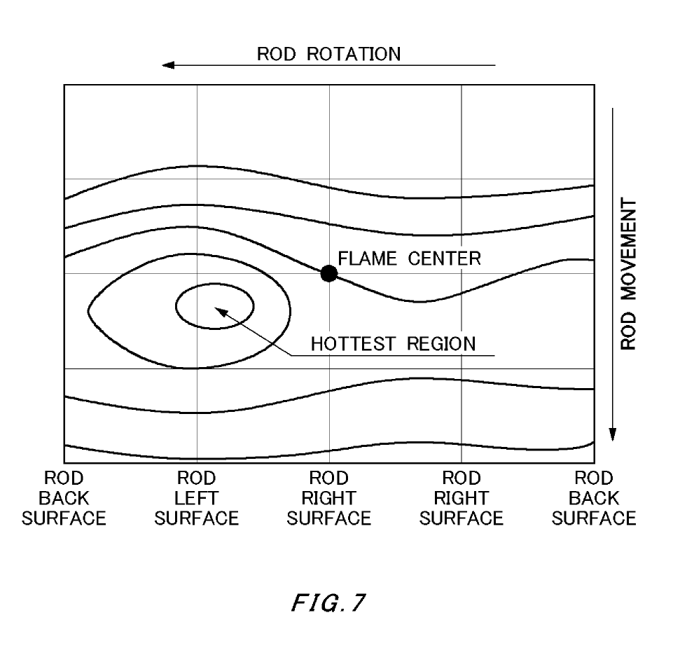

As shown in FIG. 7, the heated glass rod 6 experiences temperature distribution in the direction of rotation as well as the longitudinal direction. The position in the rotational direction at which the hottest region occurs is affected by the outer diameter of the glass rod 6, the size of the plasma flame, the rotational speed of the glass rod 6, and the like, but the hottest region is always downstream in the rod rotation. When deposition is prevented by the deposition obstructing gas nozzle 10 blowing a gas toward the glass particle flow causing the hottest region, the increase in the refractive index is maximized. In other words, the arrangement shown in FIG. 6 is more effective than the arrangement shown in FIG. 5.

The plasma torch is provided with glass raw material only during the forward movement of the glass rod, at which time silicon tetrachloride, silicon tetrafluoride, argon, and oxygen are supplied. During the backward movement, only argon and oxygen are supplied, without the raw material gases, and so the rod may return quickly to a reference position. The same effect can be achieved by using a gas containing fluorine other than the silicon tetrafluoride as the dopant, such as ethane hexafluoride, sulfur hexafluoride, or the like. Hereinafter, some embodiments and a comparative example of the present invention will be described, but the invention is not limited to these embodiments.

### FIRST EMBODIMENT

A fluorine-doped quartz glass layer was formed by using a high frequency induction thermal plasma torch to deposit glass particles on a quartz glass rod that has an outer diameter of 50 mm and a length of 1,100 mm and that moves up and down vertically while rotating.

The velocity of the glass rod relative to the plasma torch during forward movement was set to 75 mm/min, and the plasma torch was supplied with argon, oxygen, silicon tetrachloride, and silicon tetrafluoride. The direction of the forward movement was set to be downward. Forced cooling nozzles were provided above and below the plasma torch, and each forced cooling nozzle blows room-temperature air at a rate of 30 L/min to cool the upper and lower edges of the portion undergoing deposition. Cool air induction openings were formed above and below the reaction chamber, and each cool air induction aperture supplies air cooled to 10 decrees Celsius at a rate of 200 L/min. As shown in FIG. 5, the deposition obstructing gas nozzle was positioned to form a 90-degree angle with the plasma torch 1 and was positioned upstream relative to the rotational direction of the rod. The deposition obstructing gas nozzle 10 is directed toward a position 35 mm below the central peak of the plasma torch 1, and blows room temperature air at a rate of 50 L/min. The power supplied to the plasma torch 1 was set to 61 kW, which is the minimum power needed to convert the glass raw material into glass.

The velocity of the glass rod relative to the plasma torch during backward movement was set to 500 mm/min, and the plasma torch was supplied with argon and oxygen. The power supplied to the plasma torch 1 during the backward movement was set to 8 kW, which is the minimum power needed to safely maintain the plasma.

Under these conditions, a fluorine-doped glass layer was formed by repeated deposition over the course of 60 full trips of the glass rod backward and forward over the plasma torch. Upon analyzing the refractive index distribution of the resulting preform, the relative refractive index difference was found to be 1.73%.

### SECOND EMBODIMENT

The forced cooling nozzle 8 was provided only above the plasma torch, as shown in FIG. 4, and blew room-temperature air onto the glass rod 6 at a rate of 30 L/min to cool the upper edge of the region undergoing deposition. The gas guide tube 11 was provided immediately below the plasma torch 1. A fluorine-doped glass layer was formed on the glass rod by repeated deposition over the course of 60 full trips of the glass rod backward. and forward over the plasma torch, in the same manner as in the First Embodiment, aside from the obstruction of the glass particle flow below the plasma flame. Upon analyzing the refractive index distribution of the resulting preform, the relative refractive index difference was found to be 1.85%.

### THIRD EMBODIMENT

A fluorine-doped glass layer was formed on the glass rod by repeated deposition over the course of 60 full trips of the glass rod backward and forward over the plasma torch, in the same manner as in the First Embodiment, except that the deposition obstructing gas nozzle 10 was positioned to form a 90-degree angle with the plasma torch 1 and was positioned downstream relative to the rotational direction of the rod, as shown in FIG. 6. Upon analyzing the refractive index distribution of the resulting preform, the relative refractive index difference was found to be 1.83%.

### FIRST COMPARATIVE EXAMPLE

A fluorine-doped quartz glass layer was formed by using a high frequency induction thermal plasma torch to deposit glass particles on a quartz glass rod that has an outer diameter of 50 mm and a length of 1,100 mm and that moves up and down vertically while rotating.

The velocity of the glass rod relative to the plasma torch during forward movement was set to 75 mm/min, and the plasma torch was supplied with argon, oxygen, silicon tetrachloride, and silicon tetrafluoride. The direction of the forward movement was set to be downward. Forced cooling nozzles were provided above and below the plasma torch, and each forced cooling nozzle blows room-temperature air at a rate of 30 L/min. Air cooled to 10 decrees Celsius was supplied from top and bottom portions of the reaction chamber at a rate of 200 L/min. The power supplied to the plasma torch was set to 61 kW, which is the minimum power needed to convert the glass raw material into glass.

The velocity of the glass rod relative to the plasma torch during backward movement was set to 500 mm/min, and the plasma torch was supplied with argon and oxygen, but the silicon tetrachloride and the silicon tetrafluoride, which are the glass raw material and the fluorine source, were not supplied. The power supplied to the plasma torch 1 during the backward movement was set to 8 kW, which is the minimum power needed to safely maintain the plasma.

Under these conditions, a fluorine-doped glass layer was formed by repeated deposition over the course of 60 full trips of the glass rod backward and forward over the plasma torch. Upon analyzing the refractive index distribution of the resulting preform, the relative refractive index difference was found to be 1.62%, which is lower than that of the First Embodiment and the Second Embodiment.

As made clear form the above, the present invention can be used to obtain an optical fiber with a large relative refractive index difference Δ.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. A method for manufacturing an optical fiber preform, comprising:
synthesizing glass particles using a plasma flame generated by a plasma torch;
depositing the glass particles on a glass rod by blowing the glass rod with the plasma flame while the glass rod moves relative to the plasma torch; and
narrowing, in a direction of the relative movement, a region in which the glass particles in the plasma flame are affixed to the glass rod.

2. The method according to claim 1, wherein
the depositing includes causing the glass rod to move in a direction parallel to a length of the glass rod.

3. The method according to claim 1, wherein
the depositing includes causing the glass rod to rotate on an axis that is parallel to a length of the glass rod.

4. The method according to claim 1, wherein
the narrowing includes obstructing affixation of the glass particles on the glass rod in a front portion of the region, where the front portion is blown by the plasma flame before a rear portion of the region.

5. The method according to claim 4, wherein
the obstructing includes blowing gas onto the plasma flame in a direction that intersects with a direction in which the plasma flame is blown to the glass rod.

6. The method according to claim 5, wherein
the obstructing includes blowing the gas along a surface of the glass rod.

7. An apparatus for manufacturing an optical fiber preform, comprising:
a plasma torch that synthesizes glass particles in a plasma flame;
a depositing section that deposits the glass particles on the glass rod by blowing the glass rod with the plasma flame while the glass rod moves relative to the plasma torch; and
a limiting section that narrows, in a direction of the relative movement, a region in which the glass particles in the plasma flame are affixed to the glass rod.

8. The apparatus according to claim 7, wherein
the depositing section moves the glass rod in a direction parallel to a length of the glass rod.

9. The apparatus according to claim 7, wherein
the depositing section rotates the glass rod on an axis that is parallel to a length of the glass rod.

10. The apparatus according to claim 7, wherein
the limiting section includes an obstructing section that obstructs affixation of the glass particles on the glass rod in a front portion of the region, where the front portion is blown by the plasma flame before a rear portion of the region.

11. The apparatus according to claim 10, wherein
the obstructing section includes a nozzle that blows gas onto the plasma flame in a direction that intersects with a direction in which the plasma flame is blown to the glass rod.

12. The apparatus according to claim 11, wherein
the obstructing section includes a guiding section that blows the gas along a surface of the glass rod.
